(19) United States
(12) Patent Application Publication
(10) Pub. No.: US 2018/0350016 A1
(43) Pub. Date: Dec. 6, 2018

(54) METHOD, APPARATUS, AND SYSTEM FOR PREDICTIVE MANAGEMENT OF COLLEGE SEARCH INFORMATION AND SELECTION INFORMATION

(71) Applicant: Bradley Ward, Seguin, TX (US)

(72) Inventor: Bradley Ward, Seguin, TX (US)

(21) Appl. No.: 15/614,212

(22) Filed: Jun. 5, 2017

(51) Int. Cl. G06Q 50/20; G06F 17/30; G06N 5/02

(52) U.S. Cl. CPC G06Q 50/2053; G06N 5/022; G06F 17/30864

(57) ABSTRACT

System, apparatus and method for predictive management of college application information and college selection information may include a college admission event information handler and an application submission engine that may access a predictive college enrollment decision model, the college enrollment decision model building a financial aid offer model including an express strategic aid offer component determined from an express model of a strategic enrollment management system for a college.

### CROSS-REFERENCE TO RELATED APPLICATIONS

None.

### FIELD OF THE INVENTION

This disclosure relates to methods, apparatus and systems for management of college search information. This disclosure also relates to methods, apparatus and systems for management of college selection information.

### BACKGROUND

Unless otherwise defined, all terms (including technical and scientific terms) used herein have the same meaning as commonly understood by one of ordinary skill in the art to which this disclosure belongs. It may be further understood that terms, such as those defined in commonly used dictionaries, may be interpreted as having a meaning that is consistent with their meaning in the context of the relevant art and the present disclosure, and may not be interpreted in an idealized or overly formal sense unless expressly so defined herein.

The present disclosure will inform those of ordinary skill in the art that existing methods, apparatus and systems for prospective students to manage college search information and college selection information have various disadvantages, which may be previously unrecognized, or unresolved, by the exercise of ordinary skill. Such disadvantages may be solved by subject matter of this disclosure.

Need exists for improved methods, apparatus and systems for management of college search information and college selection information by prospective students, that may provide more effective, timely and lower expense for management of college search information and college selection information, improved engagement with the prospective student user, and may provide improved college selection decision information for prospective students. A method for college selection may include improved college selection information. Such a method may include determining college search information by performing college search methods with search criteria and search information of improved reliability, predictive quality, and relevance to such decisions. Such a method may include determining college decision information by performing college decision methods with decision criteria and decision information of improved reliability, predictive quality, and relevance to such decisions.

### BRIEF SUMMARY OF THE INVENTION

Disclosed subject matter includes methods, apparatus and systems for predictive management of college search information which provide and include reliable, complete and end-to-end management of college search information. Disclosed subject matter includes methods, apparatus and systems for predictive management of college search information which may provide decision information and decision criteria to a prospective student, and may enable decisions by the prospective student, that are informed by inferred or derived predictive information, based on inferred or derived predictive criteria, that are not directly verifiable from the colleges and not directly made available to prospective students by the colleges. Disclosed subject matter includes methods, apparatus and systems for predictive management of college selection information which provide and include reliable, complete and end-to-end management of college search information. Disclosed subject matter includes methods, apparatus and systems for predictive management of college selection information which may provide decision information and decision criteria to a prospective student, and may enable decisions by the prospective student, that are informed by inferred or derived predictive information, based on inferred or derived predictive criteria, that are not directly verifiable from the colleges and not directly made available to prospective students by the colleges. Disclosed subject matter includes methods, apparatus and systems which may include reliable decision methodologies and may provide reproducible college search decision processes, reproducible college search information, reproducible college selection decision processes, reproducible college decision information, or reproducible outcomes. Methods and systems as disclosed herein may use information management protocols of improved reliability, and including more complete decision methodologies, which may eliminate or overcome related disadvantages. Some advantages provided by disclosed subject matter may include, for example, more predictable college search decisions and college selection decisions. Advantages may include that improved, predictable college selection decisions may be reached using methods and systems as herein disclosed.

Traditional college search methods and systems typically are limited, implicitly or explicitly, in considering only information which is provided by the prospective student, such as the student's academic qualifications and financial information for the student's family, and publicly available information that is reported by colleges, such as reported academic profile of students admitted and enrolled in classes, full tuition cost, selectiveness among applicants such as percentage of admission offers relative to the number of applications, and reported average financial aid to students. Traditional college search systems also typically require much time and expense for students to prepare and submit applications to a selected group of colleges, which may be of interest to the student for different and varying reasons. For example, applications may be submitted to some higher ranked institutions which may provide offers of admission, but are less likely or unlikely to admit the prospective student, because other applicants have higher academic qualifications, do not need financial aid, or both. Applications also may be submitted to at least one lower ranked backup choice, in case the student is not admitted to her college of first choice, or is admitted to her first choice but does not receive an offer of financial aid that is adequate for her, and family, to pay the expected cost of attendance at her first choice. Additionally, the expense of multiple college application fees, and time burden to prepare applications, typically prevents prospective students from submitting applications to more than a small group of institutions. The application process and application fees thus can be considered as limiting choice for each individual student, in a practical sense. Other institutions typically are culled out by prospective students due to distance from home, setting, and program considerations. Prospective students, and their families, often eliminate from consideration high cost private colleges which are highly admired and distinguished in national or regional rankings and surveys of institutional reputation or education value, because these colleges typically have the highest sticker price for tuition and cost of attendance, and thus are perceived to cost more than the prospective student, and family, can reasonably pay for college education of the student. This type of self-elimination may occur, for example, where the prospective student has poor information and little guidance for making her initial decisions to incur the substantial initial expense of submitting college applications, which can quickly exceed $1,000 for submitting applications to 4-6 institutions, where she is the first in her family to attend college, English is not the first language of her parents, suffers financial disadvantage or is impoverished, or attends a low-quality secondary school with poor college guidance. In many instances, this self-elimination is a correct and reasonable decision, because the prospective student and family determine that they cannot reasonably afford the cost of attendance. However, in many instances, self-elimination by truly elite students, or students with less than elite but very high academic capabilities, may occur where the student would have received an offer of financial aid adequate to fund her cost of attendance at a distinguished college, but she was not aware of this opportunity made possible by an offer of financial aid from the distinguished institution, at the time she found it necessary to prepare and submit her college applications with her payment of the corresponding application fee for each college application. Self-elimination may also occur where prospective students have poor understanding of the criteria and availability for colleges to offer different sources or types of financial assistance such as, for example, merit-based aid, need-based aid, and strategic aid offers. The practice of utilizing strategic enrollment management systems to make strategic aid offers, in particular, is not emphasized, and is not differentiated and publicly reported as such. Perhaps in part, the criteria, practices and objectives of strategic enrollment management systems utilized by many colleges, are not directly and publicly explained to the public and prospective applicants, because strategic aid offers and practices are subject to criticism for being enacted to benefit institutions with increased revenue from a pool of prospective students, while functioning to the detriment of some students. Strategic enrollment management systems may generate strategic aid offers which, incidentally, benefit certain elite students, such as elite students from disadvantaged backgrounds or particular minorities, to attend a distinguished institution with little or no expenditure of family financial resources. Strategic enrollment management systems, on the other hand, in different circumstances can involve the making of business decisions by institutions that are of questionable benefit to other, less-qualified students or contrary to the financial interests of less-qualified students. Strategic aid offers can be criticized for consistently benefiting the financial position or academic profile of the institution, benefiting the financial and educational interests of certain elite students, increasing financial burden on some less-qualified students and their families, and potentially harming educational outcomes for some less-qualified students. Strategic aid offers also are subject to criticism for being opaque and hidden from public review, to benefit an institution that is operating to maximize net revenue for the institution from each class of students making application to the college, while organized and operating as a tax-exempt entity. College admission and college financial aid practices also may be criticized for enabling the institutions to share pricing information and exercise control over the marketplace, limit direct competition, and control the process and information available for individuals to evaluate options, purchase and finance college education.

Existing methods and systems may misdirect, misinform or steer prospective students to reach or make imprecise, over-inclusive, under-inclusive or irrational search decisions, application decisions, acceptance decisions, or financial decisions based on reasoning, decision criteria or decision information that is improper, invalid, based on incorrect assumptions, not well-considered, when compared to other identifiable options which are superior in one or more aspects. Such existing methods and systems, omitting reference to reliable, complete or end-to-end information management protocols, methods and decision methodologies, also may suffer disadvantage in that college selection decisions may be based upon ad hoc considerations, and such decisions may be flawed by incorporating or referring to ad hoc, incomplete, inaccurate, uncertain, conflicting, incorrectly defined, imprecise, or undifferentiated information. Such existing methods and systems, omitting reference to reliable, complete or end-to-end information management protocols and decision methodologies, also may suffer disadvantage in that college selection decisions may be based upon ad hoc or demonstrably erroneous or incomplete decision processes, erroneous or incomplete decision criteria, or decision criteria that are unduly limited by time available for the prospective student to engage in the college search and selection process. Such existing methods and systems, omitting reference to reliable, complete or end-to-end information management protocols and decision methodologies, also may suffer disadvantage in that college search and selection decisions may be based upon college search information or decision criteria for identifying, considering and selecting among colleges, that are incomplete or subject to manipulation by the colleges for the purpose of achieving the enrollment goals or financial goals of the colleges, and that such goals of colleges may be pursued independent of, without reference to, or in conflict with, the welfare of individual prospective students or their financially responsible family members. It will be understood that, for example, college search information or decision criteria may be limited, or manipulated, in view of formal or informal understandings among colleges, as may be reached and disseminated by rules or policies set by cooperation, consent or agreement of organizations serving colleges and universities such as, for example, The College Board®, Council for Higher Education Accreditation (CHEA), or the National Council for Higher Education (NCHE).

Existing methods and systems to search for colleges, reach decisions to apply for admission, managing applications, selecting a college, and enrolling, may be incomplete in an ad hoc, informal basis. Existing systems for managing college applications may be of limited utility, at least because such systems reduce or simplify college search information and college application decisions to considering a small amount of applicant information reflected in a small group of data points provided by the applicant using the system, and a small amount of college information reflected in a small group of data points provided by the system as reflective of the colleges. Examples of data points provided by the user may be: (i) major field of study; (ii) preferred college size in terms of enrollment; (iii) college location; (iv) preference for a private or a public institution; (v) secondary school GPA; (vi) admission test score; and (vii) financial aid information. Examples of data points provided by the system as reflective of the colleges may include: (i) popular major fields of study; (ii) enrollment; (iii) location; (iv) private or public institution; (v) enrolling class average or median secondary school GPA; (vi) enrolling class average or median admission test scores; (vii) tuition; and (viii) financial aid policy. These search systems may identify a number of colleges, provide reports on colleges, and generate a report based upon the inputs provided by the user. These reports may indicate that a particular college identified in the report has a program in the chosen field of study, a student population that may be substantially similar to the input provided by the user, and a location that may be within some range of the location data provided by the user. It may remain for the user to review the generated college report and make an application decision for themselves. Little information may be provided in terms of constructive suggestions. The applicant user may be effectively left to perform what may be many hours of research on each of the various institutions identified by the system, in an effort to determine the applicant user's eligibility to attend a particular institution, and to identify which institutions may be an appropriate match for the applicant user. Existing college search systems typically leave prospective students to make financial decisions regarding submission of college applications with limited information, or no understanding, of opaque strategic enrollment management practices of the colleges. Existing college search systems also typically place many prospective students, particularly students with average or low academic qualifications, and students where their family holds assets, in a weak bargaining position relative to each college, because each college is first provided the college admission application, application fee, student academic profile information, and family financial information, which can be considered together with all other applications received from other prospective students, such that each college can determine net pricing and terms for the student to purchase college education, and can do so with common understanding of family financial information from the standard FAFSA, and shared information about admission practices and financial aid practices of other colleges where the particular student has applied, because each college requires the prospective student to disclose all colleges where they have submitted applications for admission. Need exists for improved methods, apparatus and systems for college application information and college selection information, at least because information available to prospective students and colleges is asymmetrical, with the colleges having many advantages that enable the use of strategic enrollment management systems to benefit the institutions at the expense of prospective students and students who enroll, for example, by increasing net cost of attendance for many students, increasing average time to earn a degree, and increasing the probability of less qualified students dropping out for reasons of academic difficulty or financial difficulty before completing a degree program. Need exists for improved methods, apparatus and systems for management of college application information and college selection information for prospective students.

### BRIEF DESCRIPTION OF THE DRAWINGS

FIG. 1 is a flow chart illustrating a method for predictive management of college search information and college selection information in an exemplary embodiment.

FIG. 2 is simplified block diagram illustrating aspects of a method for predictive management of college search information and college selection information in an exemplary embodiment shown generally in FIG. 1.

FIG. 3 is simplified block diagram illustrating a system for predictive management of college search information and college selection information in an exemplary embodiment.

FIG. 4 is simplified block diagram illustrating a system for predictive management of college search information and college selection information in an exemplary embodiment shown generally in FIG. 3.

FIG. 5 is simplified block diagram illustrating a system for predictive management of college search information and college selection information in an exemplary embodiment.

FIG. 6 is a flow chart illustrating a method for predictive management of college search information and college selection information in an exemplary embodiment.

In the drawings, similar elements may be similarly numbered whenever possible. However, the practice is simply for convenience of reference and to avoid unnecessary proliferation of numbers, and is not intended to imply or suggest that an embodiment requires identity in either function or structure in the several embodiments.

### DETAILED DESCRIPTION OF EMBODIMENTS

The terminology used herein may be for the purpose of describing particular embodiments only and may be not intended to be limiting. As used herein, the singular forms “a”, “an”, and “the” are intended to include the plural forms as well, unless the context clearly indicates otherwise. It may be further understood that the terms “may be” and/or “being” or “includes” and/or “including” when used in the specification, specify the presence of stated features, regions, integers, steps, operations, elements, and/or components, but do not preclude the presence or addition of one or more other features, regions, integers, steps, operations, elements, components, and/or groups thereof.

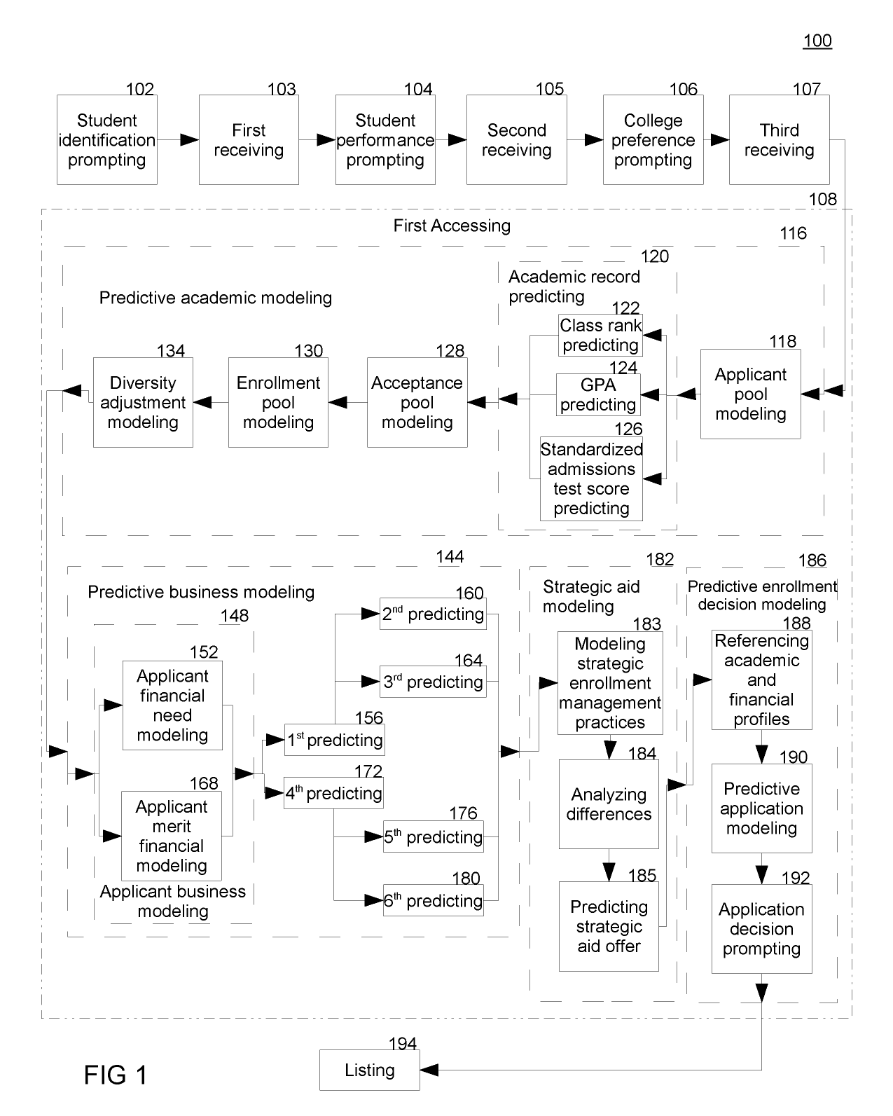

FIG. 1 is a flow chart illustrating aspects of a method 100 for predictive management of college search information and college selection information, in an exemplary embodiment. As used herein, “college” may include universities or any higher education institution or program where tuition is charged to students. Method 100 may include the step of student identification prompting 102 to request student identification information for a prospective student from the user. It will be understood that the user of a system enabling method 100 may be the prospective student or any person authorized to perform a college search, or to enter information to perform a college search, for the prospective student or on behalf of the prospective student. Student identification prompting 102 may include displaying a user interface. It will be understood that such a user interface may be displayed in any suitable display, and that such a display may be operably connected to a processor for control by same, such as via a display adapter, or may be operable in any other suitable manner. Method 100 may include first receiving 103 student identification information for a prospective student from the user responsive to the student identification prompting 102. The first receiving 103 may be enabled by operation of any suitable user input device such as, for example and without limitation, a keyboard, mouse, touch screen, or microphone of a system enabling method 100. The student identification information may include, for example and without limitation, student name, student address, student birth date, gender, race or ethnicity, Veteran status, secondary school, and other student identification information. Method 100 may include the step of student performance prompting 104 to request historical student performance information for a prospective student from the user. Method 100 may include second receiving 105 student performance information responsive to the student performance prompting 104. The student performance information may include secondary school grade information, class rank, standardized test score information, college entrance test score information for the SAT and/or ACT, status as a National Merit Scholar or related lesser status such as finalist or semifinalist, academic awards, extracurricular program awards, and other historical student performance information for the prospective student.

Method 100 may include the step of college preference prompting 106 to request student college preference information for a prospective student from the user. College preference prompting 106 may include displaying a user interface. Method 100 may include third receiving 107 student college preference information for a prospective student from the user, responsive to the college preference prompting 106. Student college preference information may include identification information for a plurality of preselected colleges, each being a college that is preselected by the prospective student for performing a college search. As used herein, “preselected college” may include, in addition to a college preselected by the prospective student, a college which has been pre-identified, identified, pre-assigned, assigned, designated or pre-designated on behalf of the prospective student, such as by the user or an advisor, for performing a college search. It will be understood that the user may provide identification information for each such preselected college. In an embodiment, such student college preference information may include identification information for a plurality of preselected colleges. It will be understood that, in an embodiment, method 100 may include automated providing of identification information for at least one preselected college or a plurality of preselected colleges, for example, to supplement a group of colleges preselected by the prospective student. It will be understood that at least one preselected college, or a plurality of preselected colleges, may be identified to enable relative comparison of college search information available for colleges, by the prospective student, for a plurality of colleges that may be identified in accordance with method 100. Criteria for relative comparison of college search information for a plurality of colleges may include, for example and without limitation, information available about particular college costs, student academic profile information, class academic profile information, location, faculty quality, majors or courses of study, ranking of particular majors or courses of study, job placement information, college reputation, college ranking in polls, extracurricular programs, fraternity/sorority opportunities, student satisfaction information, and information regarding selection of undergraduates to graduate and professional schools, size of institution by undergraduate enrollment or class size, public or private institution, state or region of the country, rural or urban setting, availability of an ROTC program, affiliation with a particular religion or church, sports programs, and status in NCAA division I, II or III.

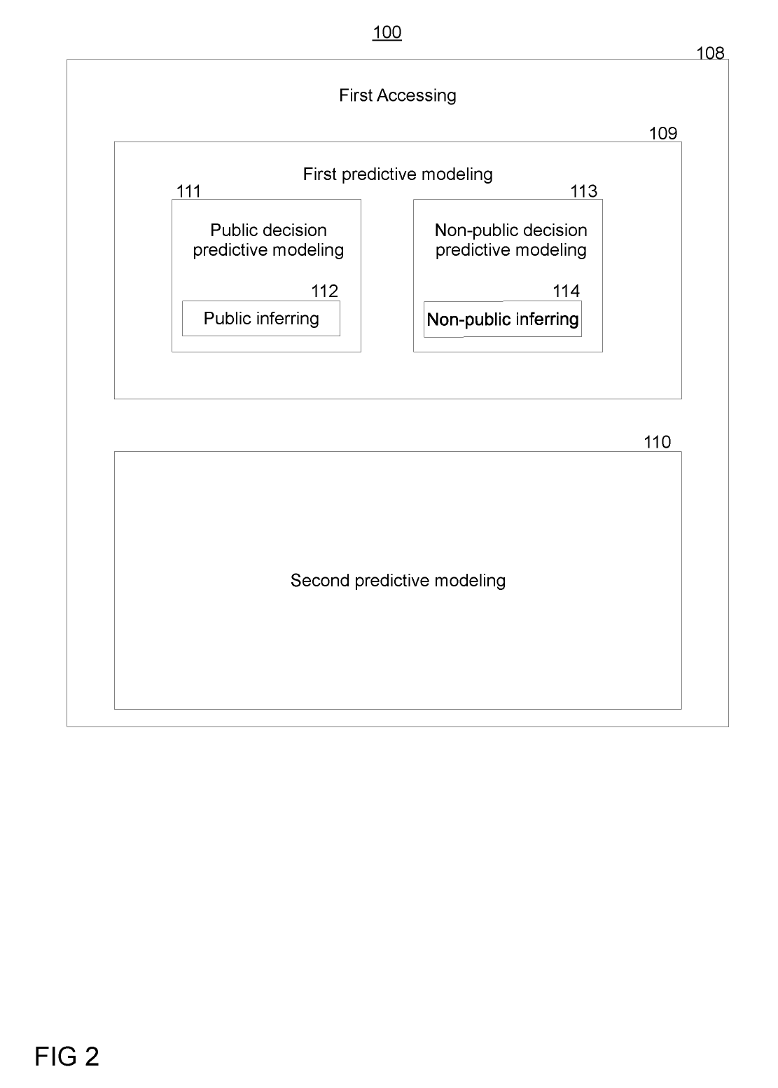

Referring to FIG. 1, method 100 may include first accessing 108 a predictive college recommendation engine. Referring to FIG. 2, first accessing 108 a predictive college recommendation engine may include first predictive modeling 109 of institutional decisions and second predictive modeling 110 of prospective student decisions. First predictive modeling 109 of institutional decisions may include public decision predictive modeling 111 in relation to public information regarding decisions of a college. Public decision predictive modeling 111 may include public inferring 112 of public decisions of a college in relation to public information for the college. First predictive modeling 109 of institutional decisions may include non-public predictive modeling 113 in relation to non-public information regarding decisions of a college. Non-public predictive modeling 113 may include non-public inferring 114 of non-public decisions of a college in relation to non-public information for the college. First accessing 108 a predictive college recommendation engine may include predictive modeling of institutional decisions that includes inferring or deriving institutional decision criteria, decision strategies, and institutional objectives of a college, where the same may, or may not, be expressly acknowledged in information made generally available by the college to prospective students. Such predictive modeling of institutional decisions may include, for example, modeling and predicting admission decisions, predicting academic aid awards, predicting merit-based financial aid offers, predicting need-based financial aid offers, and predicting strategic aid offers by a college to prospective students. Predictive modeling of institutional decisions may include modeling of institutional strategic enrollment management systems, including but not limited to modeling or prediction of predicted strategic aid offers to a prospective student. Predictive modeling may include harvesting information over a network. Second predictive modeling 110 of prospective student decisions may include predicting prospective student decisions in relation to student preferences and student welfare considerations including, for example, predicted cost of attendance and predicted financial aid offers.

Referring to FIG. 1, method 100 may include predictive academic modeling 116 of academic information for prospective colleges. It will be understood that predictive academic modeling 116 may be performed for each prospective or preselected college that is the subject of a college search for the prospective student. Method 100 may include automated enlargement of the scope of colleges, or automated suggesting of additional colleges, for the search. Additional colleges may be suggested or may include colleges identified as sharing common characteristics with preselected colleges identified by the user for the prospective student.

Referring to FIG. 1, predictive academic modeling 116 may include applicant pool modeling 118 to predict an academic profile for a model applicant pool of prospective students predicted to submit applications for admission to the college. Applicant pool modeling 118 may include constructing a predicted academic profile for a model applicant pool of prospective students, who are predicted to submit applications for admission to the college. It will be understood that constructing a predicted academic profile for a model applicant pool of prospective students, who are predicted to submit applications for admission to the college, may be constructed by predicting in relation or reference to at least one known, reported, or inferred academic profile for an actual applicant pool for the college. It will be understood, for example, that an actual applicant pool for the college may include at least one actual class applicant pool for the college for an earlier year such as, for example, the preceding year or preceding academic period.

Predictive academic modeling 116 may include academic record predicting 120 of academic record characteristics for a model applicant pool of prospective students predicted to make applications for admission to the college. Academic record predicting 120 may include predicting any academic record characteristics that a college is known, believed or inferred to consider, identify or publicly disclose for an applicant pool of prospective applicants making applications for admission to the college. Academic record characteristics, for example and without limitation, may include: class rank, GPA, and standardized admission test scores such as SAT or ACT test scores. In an embodiment as shown in FIG. 1, academic record predicting 120 may include class rank predicting 122 of predicted class rank records for a model applicant pool. Class rank may be considered as an average, median or range, for a model applicant pool. In an embodiment as shown in FIG. 1, academic record predicting 120 may include GPA predicting 124 of predicted GPA records for a model applicant pool. GPA may be considered as an average, median or range, for a model applicant pool. In an embodiment as shown in FIG. 1, academic record predicting 120 may include standardized admission test score predicting 126 of standardized admission test score records for a model applicant pool. Standardized admission test score may be considered as an average, median or range, for a model applicant pool. Standardized admission test scores, for example, may include SAT and ACT scores.

Referring to FIG. 1, predictive academic modeling 116 may include acceptance pool modeling 128 to predict an academic profile for a model acceptance pool of prospective students predicted to receive offers of admission from the college. Acceptance pool modeling 128 may include constructing a predicted academic profile for a model acceptance pool of prospective students, who are predicted to receive offers of admission from the college. It will be understood that constructing a predicted academic profile for a model acceptance pool of prospective students, who are predicted to receive offers of admission to the college, may be constructed by predicting the same in relation or by reference to at least one known, reported, or inferred academic profile for an actual acceptance pool for the college. It will be understood, for example, that an actual acceptance pool for the college may include at least one actual class acceptance pool for the college for an earlier year such as, for example, the preceding year or preceding academic period. It will be understood that, in an embodiment, constructing a predicted academic profile for a model acceptance pool of prospective students, who are predicted to receive offers of admission to the college, may be constructed by predicting the same in relation, or by reference, to a model applicant pool, such as by predicting an acceptance rate in relation to the model applicant pool, or by predicting a plurality of acceptance rates in relation to subsets of the model applicant pool, for the college. Acceptance pool modeling 128 may include comparing student performance information for the prospective student from second receiving 105 with predicted academic profile for a model acceptance pool, to predict where the student performance information for the prospective student ranks or stands in relation to the predicted academic profile of the model acceptance pool. Acceptance pool modeling 128 may include predicting whether the prospective student will receive an offer of admission, by comparison to the predicted academic profile of the model acceptance pool.

Predictive academic modeling 116 may include enrollment pool modeling 130 to predict an academic profile for a model enrolled pool of students predicted to accept offers of admission and enroll in the college. Enrollment pool modeling 130 may include constructing a predicted academic profile for a model enrolled pool of students, who are predicted to accept offers of admission and enroll in the college. It will be understood that constructing a predicted academic profile for a model enrolled pool of students, who are predicted to accept offers of admission and enroll in the college, may be constructed by predicting the same in relation or by reference to a predicted enrollment yield and at least one known, reported, or inferred academic profile for an actual enrolled pool for the college. It will be understood, for example, that an actual enrolled pool for the college may include at least one actual class enrolled pool for the college for an earlier year such as, for example, the preceding year or preceding academic period. It will be understood that, in an embodiment, constructing a predicted academic profile for a model enrolled pool of prospective students, who are predicted to accept offers of admission and enroll in the college, may be constructed by predicting the same in relation, or by reference, to a model enrolled pool, such as by predicting an enrollment rate or yield in relation to the model acceptance pool, or by predicting a plurality of acceptance rates in relation to subsets of the model acceptance pool, for the college. Enrollment pool modeling 130 may include predicting whether the prospective student will accept an offer of admission, by comparison to the predicted academic profile of the model acceptance pool.

Referring to FIG. 1, predictive academic modeling 116 may include diversity adjustment modeling 134 to provide a diversity adjustment prediction to an academic profile for a model enrolled pool of students predicted to accept offers of admission and enroll in the college. Diversity adjustment prediction may include, for example and without limitation, applying a predicted diversity adjustment factor to a predicted academic profile for a model enrolled pool of students. It will be understood that diversity adjustment prediction for a model enrolled pool of students may be performed by predicting the diversity adjustment prediction or predicted diversity adjustment factor in relation, or by reference, to at least one known, reported, or inferred academic profile for an actual enrolled pool for the college, as adjusted for diversity admissions. It will be understood, for example, that an actual enrolled pool for the college may include at least one actual class enrolled pool for the college, as adjusted for diversity admissions, for an earlier year such as, for example, the preceding year or preceding academic period. It will be understood that, in an embodiment, a predicted academic profile for a model enrolled pool of prospective students, who are predicted to accept offers of admission and enroll in the college, may be constructed by predicting the same in relation, or by reference, to a model enrolled pool, as adjusted for diversity admissions, such as by predicting a diversity adjustment or providing a predicted diversity adjustment factor in relation to the model enrolled pool, or by predicting a plurality of diversity adjustments or providing a plurality of predicted diversity adjustment factors in relation to subsets of the model enrolled pool, for the college.

Referring to FIG. 1, method 100 may include predictive business modeling 144 of business information for prospective colleges. It will be understood that predictive business modeling 144 may be performed for each prospective or preselected college that is the subject of a college search for the prospective student. Method 100 may include automated enlargement, or automated suggestions for enlargement, of the scope of the search to include additional colleges identified as sharing common characteristics with the preselected colleges identified by the user.

Predictive business modeling 144 may include applicant business modeling 148 to predict a business model profile for a prospective student submitting an application for admission to the college. It will be understood that predictive business modeling 144 may include predicting a business model profile for a model applicant pool of prospective students predicted to submit applications for admission, receive offers of admission, or accept and enroll in the college. Applicant business modeling 148 may include constructing a predicted business profile for a model applicant pool of prospective students, who are predicted to submit applications for admission, receive offer of admission, or accept offers and enroll in the college. It will be understood that a predicted business profile for a model applicant pool of prospective students, who are predicted to submit applications, receive offers of admission, or accept and enroll in the college, may be constructed by predicting in relation or reference to at least one known, reported, or inferred applicant business profile for an actual applicant pool for the college. It will be understood, for example, that an actual applicant pool for the college may include at least one actual class applicant pool for the college for an earlier year such as, for example, the preceding year or preceding academic period.

Referring to FIG. 1, predictive business modeling 144 may include applicant financial need modeling 152 to predict an applicant financial need model or profile for a prospective student submitting an application to the college, receiving an offer of admission, or accepting an offer and enrolling in the college. It will be understood that applicant financial need modeling 152 may include predicting an applicant financial need model or profile for a model applicant pool of prospective students predicted to submit applications for admission, receive offers of admission, or accept and enroll in the college. Applicant financial need modeling 152 may include predicting an applicant financial need model or profile for a prospective student, by reference to, or consideration of, a financial aid application reporting income and assets of a prospective student and prospective financially responsible persons, such as family members who have indicated prospective financial responsibility for the prospective student, in relation to the college. Applicant financial need modeling 152 may include predicting an applicant financial need model or profile for a prospective student, by reference to, or consideration of, a financial aid application reporting financial resources, including assets and income, of a prospective student and prospective financially responsible persons. Applicant financial need modeling 152 may include predicting an applicant financial need model or profile for a prospective student, by comparison of such reported financial resources with costs of attendance for the college to determine a financial deficit or applicant financial need of such an applicant financial need model. Applicant financial need modeling 152 may include first predicting 156 an applicant financial need model or profile for a prospective student, by predicting availability and eligibility of a prospective student for need-based financial assistance resources, as may be necessary to satisfy a predicted deficit. It will be understood that such need-based financial assistance resources may include, for example and without limitation, need-based student loans and need-based grants. It will be understood that, in embodiments, applicant financial need modeling 152 may include second predicting 160 an applicant expected financial contribution (EFC) model or profile for a prospective student, by reference to, or consideration of, a financial aid application reporting financial resources, including assets and income, of a prospective student and prospective financially responsible persons. In an embodiment, a predicted applicant expected financial contribution (EFC) model or profile for a prospective student may include third predicting 164 by reference to, or consideration of, a financial aid application reporting financial resources including income, and excluding assets, of a prospective student and prospective financially responsible persons. In an embodiment, a predicted applicant expected financial contribution (EFC) model or profile for a prospective student may be predicted or constructed by reference to, or consideration of, a financial aid application reporting financial resources including both income and assets, of a prospective student and prospective financially responsible persons.

Referring to FIG. 1, predictive business modeling 144 may include applicant merit financial modeling 168 to predict an applicant merit financial model or profile for a prospective student submitting an application to the college, receiving an offer of admission, or accepting an offer and enrolling in the college. It will be understood that applicant merit financial modeling 168 may include predicting an applicant merit financial model or profile for a model applicant pool of prospective students predicted to submit applications for admission, receive offers of admission, or accept and enroll in the college. Applicant merit financial modeling 168 may include predicting an applicant merit financial award model or profile for a prospective student, by reference to, or consideration of, a financial aid application reporting income and assets of a prospective student and prospective financially responsible persons, such as family members who have indicated prospective financial responsibility for the prospective student, in relation to the college. Applicant merit financial modeling 168 may include predicting an applicant financial need model or profile for a prospective student, by reference to, or consideration of, a financial aid application reporting financial resources, including assets and income, of a prospective student and prospective financially responsible persons. Applicant merit financial modeling 168 may include predicting an applicant financial need model or profile for a prospective student, by comparison of such reported financial resources with costs of attendance for the college to determine a financial deficit or applicant financial need of such an applicant financial need model. Applicant merit financial modeling 168 may include predicting an applicant merit financial award model or profile for a prospective student, by predicting availability and eligibility of a prospective student for an award of merit-based financial assistance resources, as may be necessary to satisfy a predicted deficit. It will be understood that such merit-based financial assistance resources may include, for example and without limitation, merit-based student loans, merit-based grants and merit-based scholarships. It will be understood that, in embodiments, applicant merit financial modeling 168 may include fourth predicting 172 an applicant expected financial contribution (EFC) model or profile for a prospective student, by reference to, or consideration of, a financial aid application reporting financial resources, including assets and income, of a prospective student and prospective financially responsible persons. In an embodiment, a predicted applicant expected financial contribution (EFC) model or profile for a prospective student may include fifth predicting 176 by reference to, or consideration of, a financial aid application reporting financial resources including income, and excluding assets, of a prospective student and prospective financially responsible persons. In an embodiment, a predicted applicant expected financial contribution (EFC) model or profile for a prospective student may include sixth predicting 180 by reference to, or consideration of, a financial aid application reporting financial resources including both income and assets, of a prospective student and prospective financially responsible persons.

Referring to FIG. 1, method 100 may include predictive strategic aid modeling 182 to provide a prediction of strategic financial aid to be offered to a prospective student, or predicted strategic aid offer, that is expected or predicted to be extended to a prospective student as determined by a strategic enrollment management system for a college. It will be understood that a strategic aid offer may be predicted where it may be inferred or predicted that a college will use a strategic enrollment management system to recruit students, to achieve strategic management objectives of the college. It may be predicted that a strategic enrollment management system may suggest or determine that a predicted strategic aid offer may affect composition and academic profile of a predicted enrolled pool or class. It may be predicted, for example, that a strategic enrollment management system may suggest or determine that objectives or goals of the college may be served by making a predicted strategic aid offer to an elite student having high class rank, GPA or standardized admission test scores relative to the predicted median enrolled student or predicted enrolled pool, to achieve a strategic management objective of improving composition and raising the predicted academic profile of a predicted enrolled pool or class. It may be predicted, for example, that a strategic enrollment management system may suggest or determine that objectives or goals of the college may be served by making a predicted strategic aid offer to an academically less-qualified student having low class rank, GPA or standardized admission test scores relative to the predicted median enrolled student or predicted enrolled pool, to improve or raise predicted total revenue yield of a predicted enrolled pool or class. For example, a predicted strategic aid offer to an academically less-qualified student may be expected or predicted to be disproportionately higher than predicted by academic merit, where enrollment by the less-qualified student is predicted to increase predicted total revenue, such as by incenting the academically less-qualified student to enroll where she otherwise would be less likely to enroll in the college in the absence of a strategic offer of disproportionate financial aid, in favor of attending another institution, and predicted total revenue equals or exceeds the predicted strategic aid offer. It will be understood, for example, that a predicted strategic aid offer to an academically less-qualified student having low class rank, GPA or standardized admission test scores relative to the predicted median enrolled student or predicted enrolled pool, where such a student may be predicted to remain enrolled in the college for longer than the minimum, or median, period of enrollment so as to complete a degree program over the longer period. For example, where an academically less-qualified student is predicted to receive a strategic financial aid offer to encourage or increase likelihood of enrollment, it may be inferred or predicted that the college may be utilizing a strategic enrollment management system to determine, manage and achieve financial objectives of the college, such that predicted financial expenditure on behalf of the prospective academically less-qualified student may be predicted to be higher than or disproportionate in relation to the predicted median enrolled student or predicted enrolled pool. For example, where an academically qualified student is predicted to receive a disproportionate strategic financial aid offer to encourage or increase likelihood of enrollment, it may be inferred or predicted that the college may be utilizing a strategic enrollment management system to determine, manage and achieve financial objectives of the college, such that predicted financial expenditure on behalf of the prospective academically qualified student may be predicted to be higher than the predicted financial aid offer to the same prospective student, or to a prospective composite identical student presenting an identical academic model and identical business model, based only on academic modeling and business modeling of the same prospective student or prospective composite identical student, in the absence of strategic enrollment management practices directed to such financial objectives of the college. For example, where an academically qualified student reports adequate income and assets to meet the predicted cost of attendance, it may be predicted that the college utilizing a strategic enrollment management system to determine, manage and achieve financial objectives of the college, may offer less merit financial aid than would be offered to a student with identical academic qualifications who reports income and assets that are not adequate to meet the predicted cost of attendance, such that predicted financial expenditure on behalf of the prospective academically qualified student who is financially well-off may be predicted to be higher than otherwise, with the difference accruing to the benefit of the institution. It will be understood that strategic aid modeling 182 may include strategic modeling 183 of an inferred or predicted strategic enrollment management practice, or modeling plural strategic enrollment management practices, of a strategic enrollment management system for a college in relation to a prospective student. Strategic aid modeling 182 may include predicting 185 a disproportionate strategic aid offer for a prospective student having an academic profile and business profile by reference to strategic modeling 183 inferred or predicted strategic enrollment management practices and objectives of a strategic enrollment management system for a college. It will be understood that inferring or predicting utilization of a strategic enrollment management system by a college, inferring practices or objectives of utilizing a strategic enrollment management system for a college, strategic modeling 183 inferred or predicted strategic enrollment management practices and objectives for a college, and predicting 185 a disproportionate strategic aid offer for a prospective student, may include analyzing 184 differences between reported or actual enrolled classes and predicted enrolled pools, and differences between reported or actual offers of financial aid and predicted offers of financial aid, for a college in a period, such as the most recent academic year or semester.

Referring to FIG. 1, method 100 may include predictive enrollment decision modeling 186 to provide a prediction of adjusted cost of attendance for a college, for a prospective student, including predictive academic modeling, predictive business modeling, and predictive strategic enrollment modeling. Predictive enrollment decision modeling 186 may include referencing 188 academic profile and financial profile information of the prospective student in the predictive academic modeling, predictive business modeling, and predictive strategic enrollment modeling. Predictive enrollment decision modeling 186 may include predictive application modeling 190 to provide a prediction of application submission information for a prospective student for a college, including predictive academic modeling, predictive business modeling, and predictive strategic enrollment modeling. Predictive enrollment decision modeling 186 may include application decision prompting 192 to request college application submission information for the prospective student from the user, in relation to predictive application modeling 190; or predictive modeling for the prospective student for a college, including predictive academic modeling, predictive business modeling, and predictive strategic enrollment modeling with referencing 188 academic profile information and financial profile information for the particular prospective student. Method 100 may include listing 194 of colleges in relation to predictive enrollment decision modeling 186 for the prospective student.

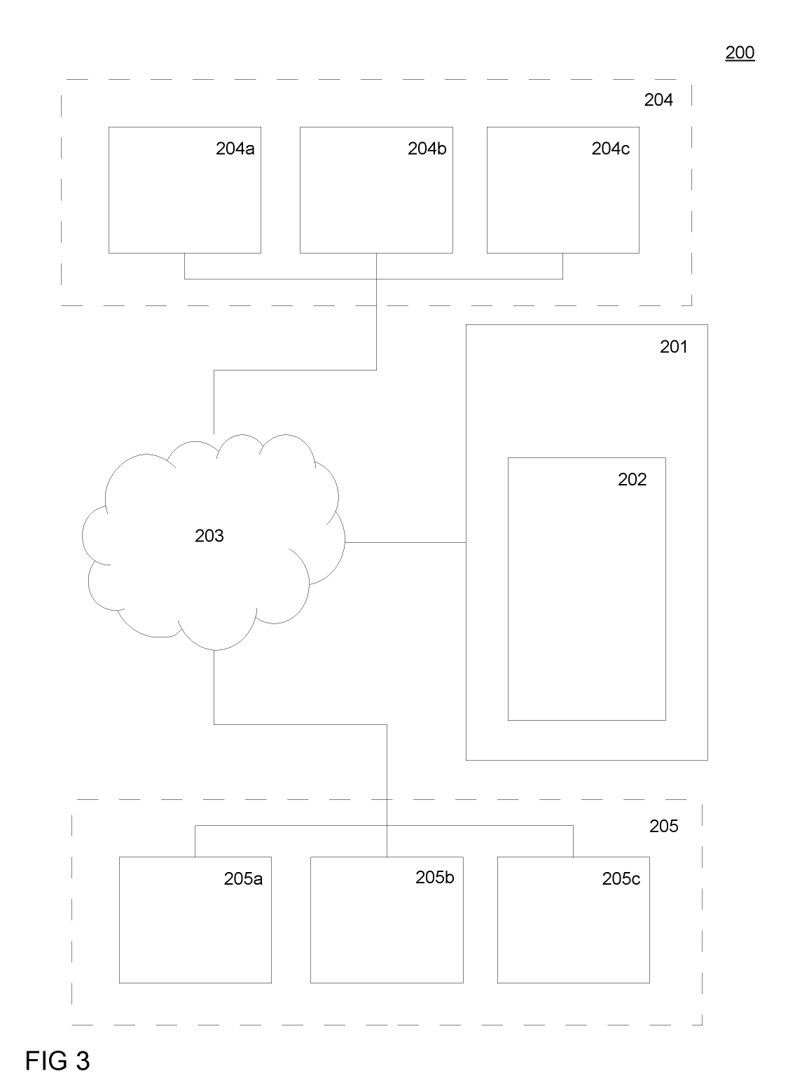

FIG. 3 is a simplified block diagram illustrating aspects of a system 200 for predictive management of college search information and college selection information, in an exemplary embodiment. System 200 may include a predictive search management system 201. Predictive search management system 201 may include a predictive search management system server 202 having a processor, in communication with a network 203. Network 203 may include, for example, the Internet or other packet communications network using any suitable protocols. System 200 may include a plurality of user devices 204 in communication with network 203. The plurality of user devices 204 may include, for example, a discreet user device (204a, 204b, 204c) for each user, with three (3) user devices (204a, 204b, 204c) being shown in the exemplary embodiment shown in FIG. 3. System 200 may include a plurality of admission event record sources 205 in communication with the network. The plurality of admission event record sources 205 may include, for example, a discreet admission event record source (205a, 205b, 205c) for each college, with three (3) admission event record sources (205a, 205b, 205c) being shown in the particular exemplary embodiment shown in FIG. 3. It will be understood that the plurality of admission event record sources may be accessible in one or more common or shared clearinghouses which may aggregate admission event record information for a plurality of colleges. Predictive search management system 201 may be configured to query, instruct, receive and send instructions and information to and from the plurality of user devices 204. Predictive search management system 201 may be configured to query, instruct and receive information from the plurality of institution admission event record sources 205.

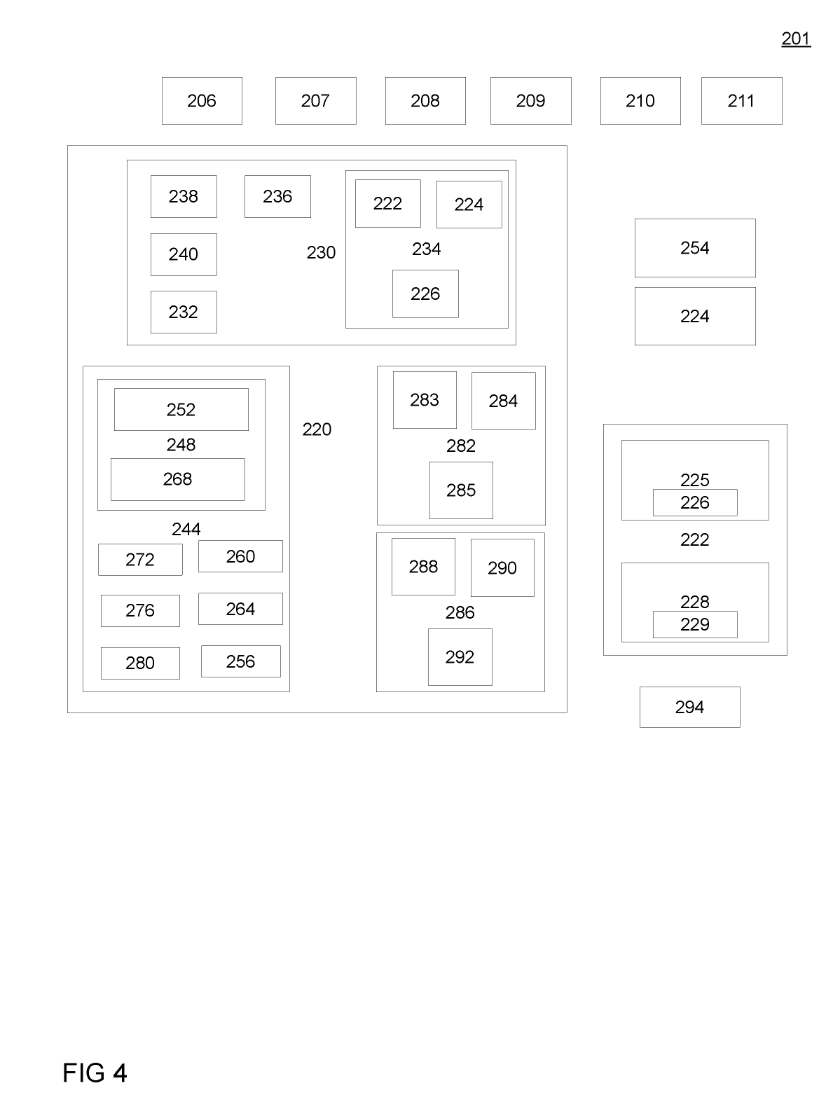

Referring to FIG. 4, predictive search management system 201 (shown generally in FIG. 3) of system 200 may include an identification prompting module 206 configured to present an identification prompt to the user, to request student identification information for a prospective student. It will be understood that the user of system 200 and predictive search management system 201 may be the prospective student or any person authorized to perform a college search, or to enter information to perform a college search, for the prospective student or on behalf of the prospective student. Identification prompting module 206 may include a user interface. It will be understood that such a user interface may be displayed in any suitable display, and that such a display may be operably connected to a processor for control by same, such as via a display adapter, or may be operable in any other suitable manner. System 201 may include first receiving module 207 for receiving student identification information for a prospective student from the user responsive to the identification prompting module 206. The first receiving module 207 may include or utilize any suitable user input device such as, for example and without limitation, a keyboard, mouse, touch screen, or microphone. The student identification information may include, for example and without limitation, student name, student address, student birth date, gender, race or ethnicity, Veteran status, secondary school, and other student identification information.

Referring to FIG. 4, predictive search management system 201 may include a student performance prompting module 208 to request student performance information for a prospective student from the user. System 201 may include second receiving module 209 for receiving student performance information responsive to the student performance prompting module 208. The student performance information may include secondary school grade information, class rank, standardized test score information, college entrance test score information for the SAT and or ACT, status as a National Merit Scholar or finalist, academic awards, extracurricular program awards, and other student performance information for the prospective student.

Referring to FIG. 4, predictive search management system 201 may include a college preference prompting module 210 to request student college preference information for a prospective student from the user. College preference prompting module 210 may include a user interface. predictive search management system 201 may include third receiving module 214 to receive student college preference information for a prospective student from the user, responsive to the college preference prompting module 210.

Referring to FIG. 4, predictive search management system 201 may include a predictive college recommendation engine 220. Predictive college recommendation engine 220 may include first predictive modeling module 222 for predicting institutional decisions and second predictive modeling module 224 for predicting prospective student decisions. First predictive modeling module 222 for institutional decisions may include public decision predictive modeling module 225 for predicting institutional decisions in relation to public information regarding decision criteria and decision modes for a college. Public decision predictive modeling module 225 may include public decision inferring module 226 for inferring institutional decisions or institutional decision criteria in relation to public information regarding decision criteria and decision modes for the college. First predictive modeling module 222 of institutional decisions may include non-public predictive modeling module 228 for predicting institutional decisions in relation to non-public information regarding decision criteria and decision modes of a college. Non-public predictive modeling module 228 may include non-public decision inferring module 229 for inferring institutional decisions or institutional decision criteria in relation to non-public information regarding decision criteria and decision modes for the college. It will be understood, for example, that non-public predictive modeling module 228 and non-public decision inferring module 229 may model and predict institutional decisions or institutional decision criteria in relation to inferred non-public information regarding inferred decision criteria and inferred decision modes for the college, where such non-public information may include inferred decision criteria and inferred decisions modes of a strategic enrollment management system which is utilized by the college. It will be understood that utilization of a non-public strategic enrollment management system by a college may be determined or inferred, for example, where admission events reported by the college diverge from a model of institutional decisions based on public information sources for the college. For example, where it is reported that the academic profile of a class admitted to a college has fallen moderately, but it is also reported that applications by highly qualified prospective students have risen sharply, modeling of institutional decisions with non-public predictive modeling module 228 and non-public decision inferring module 229 may determine that the academic profile of the admitted class or acceptance pool, which is determined in relation to a plurality of admission events reported by the college (i.e., public information for the college), diverges from a model of institutional decisions, it may be determined or inferred that a strategic enrollment management system is utilized by the college to increase revenue with a reduction of academic profile for the acceptance pool or enrolled pool. Decision criteria and decision modes associated with utilization of such a strategic enrollment management system may be determined or inferred, and utilized in the modeling and predicting by functioning of non-public predictive modeling module 228 and non-public decision inferring module 229.

Referring to FIG. 4, predictive college recommendation engine 220 also may include second predictive modeling module 224 of decisions by prospective students. Second predictive modeling module 224 may predict prospective student decisions in relation to student preferences and student welfare including, for example, predicted cost of attendance and predicted financial aid offers. Student preferences and student welfare may be expressly identified by the prospective student, inferred, determined by analysis, or calculated from student information. Modeling of student welfare may be determined to be improved, for example, where a small college is situated in a rural location if the prospective student has reported her preferences to attend a small college and one in for a rural location, etc. Student welfare may be considered to be improved where cost of attendance is reduced for an institution, although the direct financial savings may accrue to a financially responsible family member.

Referring to FIG. 4, predictive college recommendation engine 220 may include predictive academic modeling module 230 for modeling and predicting academic information for prospective colleges. It will be understood that predictive academic modeling module 230 may perform modeling and predicting of academic information for each prospective or preselected college that is the subject of a college search for the prospective student. Predictive college recommendation engine 220 may perform automated enlargement of the scope of colleges, or automated suggesting of additional colleges, for the search. Additional colleges may be suggested or may include colleges identified as sharing common characteristics with preselected colleges identified by the user for the prospective student. Referring to FIG. 4, predictive academic modeling module 230 may include applicant pool modeling module 232 to predict an academic profile for a model applicant pool of prospective students predicted to submit applications for admission to the college. Applicant pool modeling module 232 may construct a predicted academic profile for a model applicant pool of prospective students, who are predicted to submit applications for admission to the college.

Predictive academic modeling module 230 may include academic record predicting module 234. Academic record predicting module 234 may determine, model and predict academic record characteristics for a model applicant pool of prospective students predicted to make applications for admission to the college. Academic record predicting 234 may model and predict any academic record characteristics that a college is known, believed or inferred to consider, identify or publicly disclose for an applicant pool of prospective applicants making applications for admission to the college. Academic record characteristics, for example and without limitation, may include: class rank, GPA, and standardized admission test scores such as SAT or ACT test scores.

Referring to FIG. 4, predictive academic modeling module 230 may include acceptance pool modeling module 236 to predict an academic profile for a model acceptance pool of prospective students predicted to receive offers of admission from the college. Acceptance pool modeling module 236 may construct a predicted academic profile for a model acceptance pool of prospective students, who are predicted to receive offers of admission from the college. It will be understood that a predicted academic profile for a model acceptance pool of prospective students, who are predicted to receive offers of admission to the college, may be constructed by predicting the same in relation or by reference to at least one known, reported, or inferred academic profile for an actual acceptance pool for the college, as described elsewhere herein. Acceptance pool modeling module 236 may compare student performance information for the prospective student with predicted academic profile for a model acceptance pool, to predict where the student performance information for the prospective student ranks or stands in relation to the predicted academic profile of the model acceptance pool. Acceptance pool modeling module 236 may model and predict whether the prospective student will receive an offer of admission, by comparison to the predicted academic profile of the model acceptance pool.

Predictive academic modeling module 230 may include an enrollment pool modeling module 238 to model and predict an academic profile for a model enrolled pool of students predicted to accept offers of admission and enroll in the college. Enrollment pool modeling module 238 may construct a predicted academic profile for a model enrolled pool of students, who are predicted to accept offers of admission and enroll in the college, as elsewhere described herein. Enrollment pool modeling module 238 may predict whether the prospective student will accept an offer of admission, by comparing student academic information for the prospective student and the predicted academic profile of the model acceptance pool.

Predictive academic modeling module 230 may include diversity adjustment modeling module 240 to provide a diversity adjustment prediction for the prospective student in relation to a predicted diversity profile for a model enrolled pool of students. Diversity adjustment modeling module 240 may predict, for example, a diversity adjustment factor for the prospective student by comparing diversity information for the prospective student to predicted diversity profile for a model enrolled pool of students, as elsewhere described herein. It will be understood that a diversity adjustment prediction for the prospective student may be modeled and predicted in relation to predicted academic profile for the model enrolled pool modeled with a diversity adjustment prediction. For example, where a prospective student falls within a small ethnic group, a diversity adjustment prediction may be modeled and predicted by diversity adjustment modeling module 240.

Predictive college recommendation engine 220 may include predictive business modeling module 244 for modeling and predicting business information and decisions for a college. Predictive business modeling module 244 may perform modeling and predicting for each prospective or preselected college that is the subject of a college search for the prospective student. Predictive business modeling module 244 may include applicant business modeling module 248 to predict a business model profile for a prospective student submitting an application for admission to the college. It will be understood that predictive business modeling 244 also may include predicting a business model profile for a model applicant pool of prospective students predicted to submit applications for admission, receive offers of admission, or accept and enroll in the college. Applicant business modeling module 248 may include constructing a predicted business profile for a model applicant pool of prospective students, who are predicted to submit applications for admission, receive offer of admission, or accept offers and enroll in the college. It will be understood that a predicted business profile for a model applicant pool of prospective students, who are predicted to submit applications, receive offers of admission, or accept and enroll in the college, may be constructed by predicting in relation or reference to at least one known, reported, or inferred applicant business profile for an actual applicant pool for the college. It will be understood, for example, that an actual applicant pool for the college may include at least one actual class applicant pool for the college for an earlier year such as, for example, the preceding year or preceding academic period.

Predictive business modeling module 244 may include applicant financial need modeling module 252 to predict an applicant financial need model or profile for a prospective student submitting an application to the college, receiving an offer of admission, or accepting an offer and enrolling in the college. It will be understood that applicant financial need modeling module 252 may construct an applicant financial need model or profile for a model applicant pool of prospective students predicted to submit applications for admission, receive offers of admission, or accept and enroll in the college. Applicant financial need modeling module 252 may include predicting an applicant financial need model or profile for a prospective student, by reference to, or consideration of, a financial aid application reporting income and assets of a prospective student and prospective financially responsible persons, such as family members who have indicated prospective financial responsibility for the prospective student, in relation to the college. Applicant financial need modeling module 252 may include predicting an applicant financial need model or profile for a prospective student, by reference to, or consideration of, a financial aid application reporting financial resources, including assets and income, of a prospective student and prospective financially responsible persons. Applicant financial need modeling module 252 may include predicting an applicant financial need model or profile for a prospective student, by comparison of such reported financial resources with costs of attendance for the college to determine a financial deficit or applicant financial need of such an applicant financial need model. Applicant financial need modeling module 252 may include first predicting module 256 an applicant financial need model or profile for a prospective student, by predicting availability and eligibility of a prospective student for need-based financial assistance resources, as may be necessary to satisfy a predicted deficit. It will be understood that such need-based financial assistance resources may include, for example and without limitation, need-based student loans and need-based grants. It will be understood that, in embodiments, applicant financial need modeling module 252 may include second predicting module 260 an applicant expected financial contribution (EFC) model or profile for a prospective student, by reference to, or consideration of, a financial aid application reporting financial resources, including assets and income, of a prospective student and prospective financially responsible persons. In an embodiment, a predicted applicant expected financial contribution (EFC) model or profile for a prospective student may include third predicting module 264 by reference to, or consideration of, a financial aid application reporting financial resources including income, and excluding assets, of a prospective student and prospective financially responsible persons. In an embodiment, a predicted applicant expected financial contribution (EFC) model or profile for a prospective student may be predicted or constructed by reference to, or consideration of, a financial aid application reporting financial resources including both income and assets, of a prospective student and prospective financially responsible persons.

Predictive business modeling module 244 may include applicant merit financial modeling module 268 to predict an applicant merit financial model or profile for a prospective student submitting an application to the college, receiving an offer of admission, or accepting an offer and enrolling in the college. It will be understood that applicant merit financial modeling module 268 may include an applicant merit financial model or profile for a model applicant pool of prospective students predicted to submit applications for admission, receive offers of admission, or accept and enroll in the college. Applicant merit financial modeling module 268 may include an applicant merit financial award model or profile for a prospective student, by reference to, or consideration of, a financial aid application reporting income and assets of a prospective student and prospective financially responsible persons, such as family members who have indicated prospective financial responsibility for the prospective student, in relation to the college. Applicant merit financial modeling module 268 may include an applicant financial need model or profile for a prospective student, by reference to, or consideration of, a financial aid application reporting financial resources, including assets and income, of a prospective student and prospective financially responsible persons. Applicant merit financial modeling module 268 may include an applicant financial need model or profile for a prospective student, by comparison of such reported financial resources with costs of attendance for the college to determine a financial deficit or applicant financial need of such an applicant financial need model. Applicant merit financial modeling module 268 may include an applicant merit financial award model or profile for a prospective student, to predict eligibility of a prospective student and availability of an award of merit-based financial assistance resources, as may be necessary to satisfy a predicted deficit. It will be understood that such merit-based financial assistance resources may include, for example and without limitation, merit-based student loans, merit-based grants and merit-based scholarships. It will be understood that, in embodiments, applicant merit financial modeling 268 may include fourth predicting module 272 to provide an applicant expected financial contribution (EFC) model or profile for a prospective student, by reference to, or consideration of, a financial aid application reporting financial resources, including assets and income, of a prospective student and prospective financially responsible persons. In an embodiment, a predicted applicant expected financial contribution (EFC) model or profile for a prospective student may include fifth predicting module 276 including reference to, or consideration of, a financial aid application reporting financial resources including income, and excluding assets, of a prospective student and prospective financially responsible persons. In an embodiment, a predicted applicant expected financial contribution (EFC) model or profile for a prospective student may include sixth predicting module 280 which refers to, or considers, a financial aid application reporting financial resources including both income and assets, of a prospective student and prospective financially responsible persons.

Predictive college recommendation engine 220 may include predictive strategic aid modeling module 282 to provide a prediction of strategic financial aid to be offered to a prospective student, or predicted strategic aid offer, that is expected or predicted to be extended to a prospective student as determined by a strategic enrollment management system for a college. It will be understood that a strategic aid offer may be predicted where it may be inferred or predicted that a college will use a strategic enrollment management system to recruit students, to achieve strategic management objectives of the college. It may be predicted that a strategic enrollment management system may suggest or determine that a predicted strategic aid offer may affect composition and academic profile of a predicted enrolled pool or class. It may be predicted, for example, that a strategic enrollment management system may suggest or determine that objectives or goals of the college may be served by making a predicted strategic aid offer to an elite student having high class rank, GPA or standardized admission test scores relative to the predicted median enrolled student or predicted enrolled pool, to achieve a strategic management objective of improving composition and raising the predicted academic profile of a predicted enrolled pool or class. It may be predicted, for example, that a strategic enrollment management system may suggest or determine that objectives or goals of the college may be served by making a predicted strategic aid offer to an academically less-qualified student having low class rank, GPA or standardized admission test scores relative to the predicted median enrolled student or predicted enrolled pool, to improve or raise predicted total revenue yield of a predicted enrolled pool or class. For example, a predicted strategic aid offer to an academically less-qualified student may be expected or predicted to be disproportionately higher than predicted by academic merit, where enrollment by the less-qualified student is predicted to increase predicted total revenue, such as by incenting the academically less-qualified student to enroll where she otherwise would be less likely to enroll in the college in the absence of a strategic offer of disproportionate financial aid, in favor of attending another institution, and predicted total revenue equals or exceeds the predicted strategic aid offer. It will be understood, for example, that a predicted strategic aid offer to an academically less-qualified student having low class rank, GPA or standardized admission test scores relative to the predicted median enrolled student or predicted enrolled pool, where such a student may be predicted to remain enrolled in the college for longer than the minimum, or median, period of enrollment so as to complete a degree program over the longer period. For example, where an academically less-qualified student is predicted to receive a strategic financial aid offer to encourage or increase likelihood of enrollment, it may be inferred or predicted that the college may be utilizing a strategic enrollment management system to determine, manage and achieve financial objectives of the college, such that predicted financial expenditure on behalf of the prospective academically less-qualified student may be predicted to be higher than or disproportionate in relation to the predicted median enrolled student or predicted enrolled pool. Also, for example, where an academically qualified student is predicted to receive a disproportionate strategic financial aid offer to encourage or increase likelihood of enrollment, it may be inferred or predicted that the college may be utilizing a strategic enrollment management system to determine, manage and achieve financial objectives of the college, such that predicted financial expenditure on behalf of the prospective academically qualified student may be predicted to be higher than the predicted financial aid offer to the same prospective student, or to a prospective composite identical student presenting an identical academic model and identical business model, based only on academic modeling and business modeling of the same prospective student or prospective composite identical student, in the absence of strategic enrollment management practices directed to such financial objectives of the college. For example, where an academically qualified student reports adequate income and assets to meet the predicted cost of attendance, it may be predicted that the college utilizing a strategic enrollment management system to determine, manage and achieve financial objectives of the college, may offer less merit financial aid than would be offered to a student with identical academic qualifications who reports income and assets that are not adequate to meet the predicted cost of attendance, such that predicted financial expenditure on behalf of the prospective academically qualified student who is financially well-off may be predicted to be higher than otherwise, with the difference accruing to the benefit of the institution. It will be understood that strategic aid modeling module 282 may include strategic modeling module 283 including an inferred or predicted strategic enrollment management practice, or modeling plural strategic enrollment management practices, of a strategic enrollment management system for a college in relation to a prospective student. Strategic aid modeling module 282 may include predicting module 285 to predict a disproportionate strategic aid offer for a prospective student having an academic profile and business profile by reference to strategic modeling module 283 that includes inferred or predicted strategic enrollment management practices and objectives of a strategic enrollment management system for a college. It will be understood that inferring or predicting utilization of a strategic enrollment management system by a college, inferring practices or objectives of utilizing a strategic enrollment management system for a college, strategic modeling module 283 including inferred or predicted strategic enrollment management practices and objectives for a college, and predicting module 285 to predict a disproportionate strategic aid offer for a prospective student, may include analyzing module 284 to determine differences between reported or actual enrolled classes and predicted enrolled pools, and differences between reported or actual offers of financial aid and predicted offers of financial aid, for a college in a period, such as the most recent academic year or semester.

Predictive college recommendation engine 220 may include predictive enrollment decision modeling module 286 to provide a prediction of adjusted cost of attendance for a college, for a prospective student, including predictive academic modeling, predictive business modeling, and predictive strategic enrollment modeling. Predictive enrollment decision modeling module 286 may include referencing module 288 academic profile and financial profile information of the prospective student in the predictive academic modeling, predictive business modeling, and predictive strategic enrollment modeling. Predictive enrollment decision modeling module 286 may include predictive application modeling module 290 to provide a prediction of application submission information for a prospective student for a college, including predictive academic modeling, predictive business modeling, and predictive strategic enrollment modeling. Predictive enrollment decision modeling module 286 may include application decision prompting module 292 to request college application submission information for the prospective student from the user, in relation to predictive application modeling module 290; or predictive modeling for the prospective student for a college, including predictive academic modeling, predictive business modeling, and predictive strategic enrollment modeling module with referencing 288 academic profile information and financial profile information for the particular prospective student. Predictive college recommendation engine 220 may include listing module 294 of colleges in relation to predictive enrollment decision modeling module 286 for the prospective student.

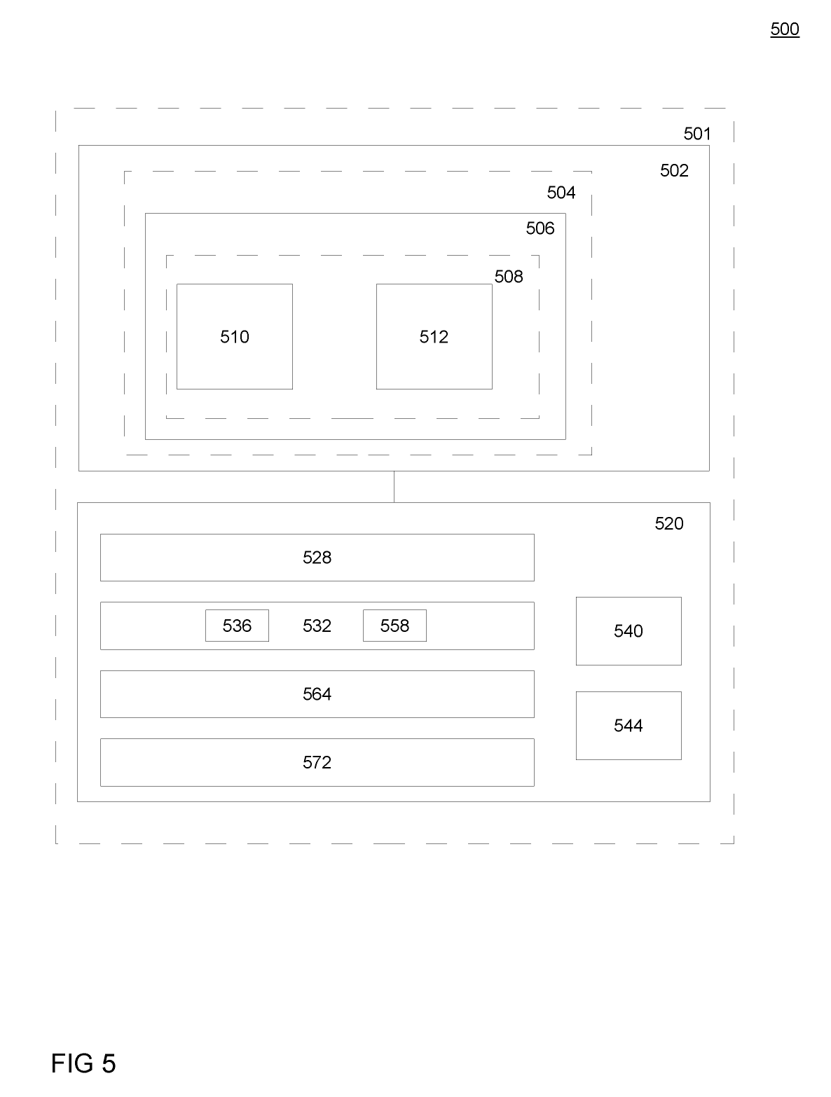

FIG. 5 illustrates a system 500 for predictive management of college admission information and college selection information in an exemplary embodiment. System 500 may be identical to system 200 described elsewhere and illustrated in FIGS. 3 and 4, except as otherwise shown in FIG. 5 or herein described. Referring to FIG. 5, system 500 may include predictive search management system 501. Predictive search management system 501 may include a college admission event information handler 502, implemented by a processor. College admission event information handler 502 may include, and may be configured to build, a college admission event model 504. College admission event model 504 may be built, for example, from historical college event information by accessing a college admission event database 506 including a plurality of college admission event representations 508 for a plurality of college admission events. Each of the college admission event representations 508 may be associated with a record of a college admission event for a college, where the college admission event representations 508 include informational aspects of college admission events reported by the college. Each of the college admission event representations 508 may be associated with a college identifier 510 and an event type 512. It will be understood that, in embodiments, a college admission event handler 502 may include and control all, or some, aspects of college admission event model 504, college admission event database 506, generating college admission event representations 508 for a plurality of college admission events, college identifiers 510 and event types 512.

Predictive search management system 501 may include a predictive college recommendation engine 520. Predictive college recommendation engine 520 may be implemented by a processor of predictive search management server 502. Predictive college recommendation engine 520 may include a query module 528 configured to receive and process queries from the user device. The query module 528, for example, may request and process from a user device the following: an applicant identifier, academic profile, financial profile, and a plurality of college identifiers corresponding to colleges preselected for a prospective student. Predictive college recommendation engine 520 may include a predictive enrollment decision model 532. It will be understood that predictive enrollment decision model 532 may be identical to predictive enrollment decision model 286 (shown in FIG. 4) in structure, configuration, and/or functions. Referring to FIG. 5, predictive enrollment decision model 532 may perform predictive enrollment decision modelling identical to predictive enrollment decision modeling 186 (shown in FIG. 1) as elsewhere described and illustrated in this disclosure. Referring to FIG. 5, it will be understood that predictive enrollment decision model 532 may be structured or configured to perform predictive enrollment decision modelling in any manner suitable to provide predictions of enrollment decisions for the prospective student for each of a plurality of colleges, consistent with methods and systems disclosed herein. Predictive enrollment decision model 532 may determine a plurality of predicted enrollment decisions 536 for an applicant associated with the applicant identifier 540. The predicted enrollment decisions 536 associated with the applicant identifier 540 may be determined in relation to the plurality of college identifiers 544 for colleges corresponding thereto.

Referring to FIG. 5, for each college identifier 544, the predictive enrollment decision model 532 may access the college admission event model 506. College admission event model 506 may be identical to college admission event model 254 (shown in FIG. 4) in structure, configuration or functions. Referring to FIG. 5, college admission event model 506 may be structured or configured to perform predictive admission event modelling in any manner suitable to provide predictions of college admission events for a plurality of colleges for the prospective student, consistent with methods and systems disclosed herein. Predictive enrollment decision model 532 may determine a predicted financial aid offer for each prospective student, for each college, or for each college where an offer of admission is predicted for the prospective student, where event type is a financial aid offer. For each college identifier 544, the predictive enrollment decision model 532 may determine a predicted financial aid offer 558 by reference to the college admission event model 506 where the event type is a financial aid offer, in relation to the academic profile and financial profile of the prospective student. Predicted financial aid offers 558 may be determined for the plurality of college identifiers 544. The predictive enrollment decision model 532 may determine predicted net cost of attendance for each college identifier 544 and each college corresponding thereto.

Referring to FIG. 5, system 500 for predictive management of college application information and college selection information may include an application submission indicator 564. Application submission indicator 564 may be provided for each college identifier 544 relative to the predicted net cost of attendance for the applicant identifier 540. In the embodiment illustrated in FIG. 5, application submission indicator 564 may receive predicted net cost of attendance for each college identifier 544 for the applicant identifier 540 from predictive enrollment decision model 532. In other arrangements, predictive enrollment decision model 532 may include all or portions of application submission indicator 564. System 500 may include a listing module 572 to generate a listing of colleges, for example, in relation to application submission indicator 564 or predicted net cost of attendance for a plurality of colleges.

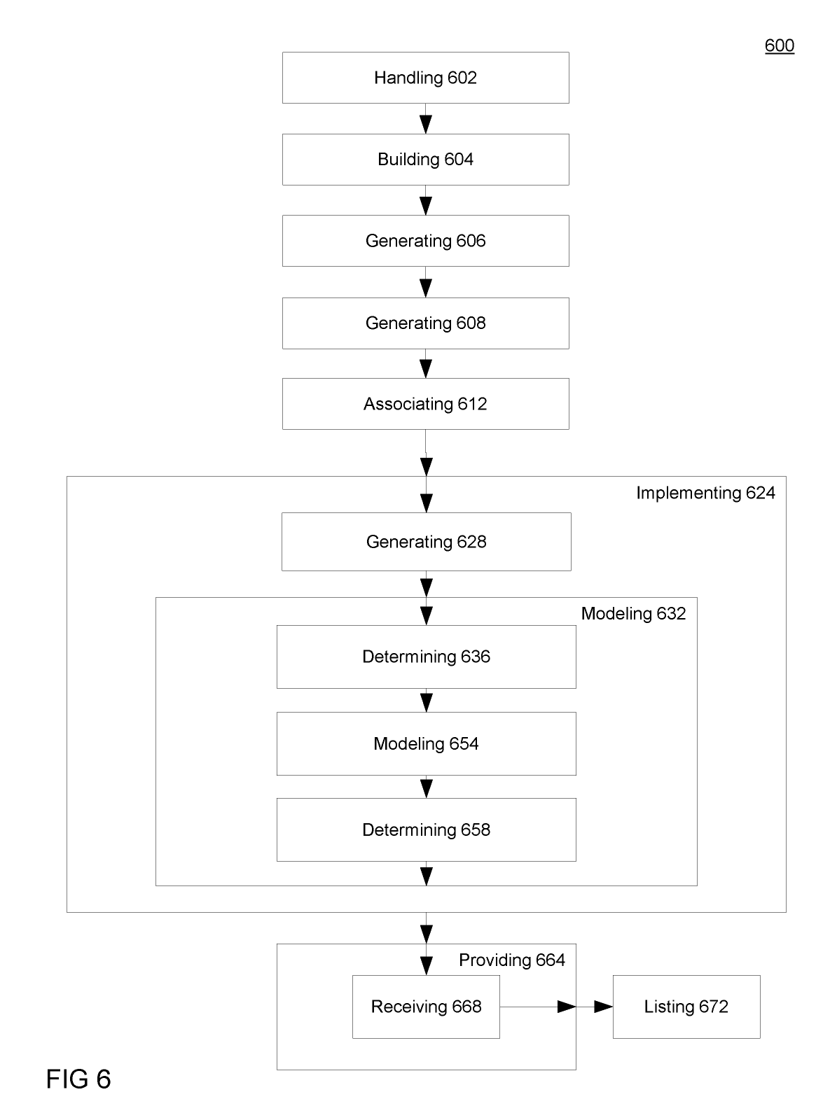

FIG. 6 illustrates a method 600 for predictive management of college admission information and college selection information in an embodiment. It will be understood that method 600 may be enabled and performed by, for example, system 500 or another suitable system providing necessary functions. Method 600 may include college admission event information handling 602, implemented by a processor. College admission event information handling 602 may include building 604 a college admission event model. College admission event handling 602 may include accessing 606 a college admission event database of historical college event information. College admission event handling 602 may include generating 606 college admission event representations for building 604 college admission event model. Each college admission event representation may be associated with a college admission event for a college. College admission event handling 602 may include generating 608 a college admission event database accessible for the college admission event model. Such a college admission event database may include, for example, a plurality of college admission event representations for a plurality of college admission events. Each of the college admission event representations may be associated with a record of a college admission event for a college, where the college admission event representations include informational aspects of college admission events reported by the college or otherwise identified by investigation or inference. College admission event handling 602 may include associating 612 college admission event representations with a college identifier and event type. It will be understood that, in embodiments, college admission event handling 602 may include aspects of building 604 a college admission event model 604, generating 608 a college admission event database, generating 606 college admission event representations, and associating 612 college admission event representations with a college identifier and event type.

Referring to FIG. 6, method 600 may include implementing 624 an application submission engine. Implementing 624 an application submission engine may be enabled or performed by a processor. Implementing 624 an application submission engine may include querying 628 a user device. Querying 628 a user device may include receiving and processing at least one query from a user device associated with a user. The querying 628 a user device, for example, may include receiving and processing from a user device an applicant identifier, academic profile, financial profile, and a plurality of college identifiers corresponding to colleges preselected for a prospective student. Implementing 624 an application submission engine may include predictive enrollment decision modelling 632. It will be understood that predictive enrollment decision modelling 632 may be identical to predictive enrollment decision modelling 186 (shown in FIG. 1) in structure, configuration, and functions. Referring to FIG. 6, predictive enrollment decision modelling 632 may perform predictive modelling of enrollment decisions for prospective students identical to aspects of predictive enrollment decision modeling 186 (shown in FIG. 1) as elsewhere described and illustrated in this disclosure. Referring to FIG. 6, it will be understood that predictive enrollment decision modelling 632 may be structured or configured to perform predictive modelling of enrollment decisions for prospective students in any manner suitable to provide predictions of enrollment decisions for the prospective student for a plurality of colleges, consistent with aspects of methods and systems disclosed herein. Predictive enrollment decision modelling 632 may include determining 636 predicted enrollment decisions for a prospective student associated with an applicant identifier for a plurality of colleges. The determining 636 predicted enrollment decisions for a prospective student associated with an applicant identifier may be determined or performed in relation to the plurality of college identifiers for colleges corresponding thereto.

Referring to FIG. 6, for each college identifier, the predictive enrollment decision modelling 632 of enrollment decisions for a prospective student associated with an applicant identifier may include modelling 654 of college admission events. Modeling 654 of college admission events may be identical to, or may include aspects of, building a college admission event model and college admission event information handling (shown in FIG. 5) in structure, configuration or functions. Referring to FIG. 6, modeling 654 of college admission events may be structured or configured to perform predictive modelling of college admission event in any manner suitable to provide predictions of college admission events for a plurality of colleges for the prospective student, consistent with methods and systems disclosed herein. Predictive enrollment decision modeling 632 of enrollment decisions may include determining a predicted financial aid offer for each prospective student, for each college, or for each college where an offer of admission is predicted for the prospective student, where event type is a financial aid offer. For each college identifier, the predictive enrollment decision modelling 632 of enrollment decisions may including predictive determining 658 of a predicted financial aid offer by reference to the modeling 654 of college admission events where the event type is a financial aid offer, in relation to the academic profile and financial profile of the prospective student. Predicted financial aid offers may be determined for the plurality of college identifiers. The predictive enrollment decision modeling 632 of enrollment decisions may include predictive determining 660 of predicted financial aid offers and predicted net cost of attendance for each college identifier and each college corresponding thereto.

Referring to FIG. 6, method 600 may include providing 664 an application submission indicator. Providing 664 an application submission indicator may be performed for each college identifier relative to the predicted net cost of attendance for an applicant identifier. In the embodiment illustrated in FIG. 6, providing 664 an application submission indicator may include receiving 668 predicted net cost of attendance for each college identifier for the applicant identifier from the application submission engine implementing 624. In other arrangements, application submission engine implementing 624 may include all or portions of providing 664 an application submission indicator. Method 600 may include listing 672 by a listing module to provide a listing of colleges, for example, in relation to providing 664 of an application submission indicator or receiving 668 predicted net cost of attendance for a plurality of colleges.

Methods, apparatus and systems for predictive management of college search information and selection information may include student information such as, for example, college preferences, location preferences, SAT college assessment scores, ACT college assessment scores, high school grade point average (“GPA”), high school class ranking, and personal classification information. Personal classification information may comprise information such as ethnicity information, socio-economic information, and similar information that may be used to further categorize the individual user.

In an example, a method or system may include utilizing the SAT and/or ACT scores of a prospective student as a first order search and filter criteria, developing a quartile rank of the student's score as compared to a selected college's data sheet average scores. As an example, consider a selected college that may indicate on its admission data sheet SAT scores for acceptance range between 1000 and 1200. An exemplary quartile of the student body may be as follows: 1250 for the top 10%, 1200 for the top 25%, 1100 for the next middle 50%, 1000 for bottom 25%.

In an example, a method or system may use the student's SAT score to determine whether the student's score lies within the top 25% quartile, the middle 50% quartile, or in the lower 25% quartile, based upon the acceptable range of SAT as defined by the selected college admission data sheet. The college search may, for example, develop a list of colleges where the student's score may be elevated as compared to a specific college student body as defined by the reported SAT scores for acceptance ranges. In this particular example, if the student's SAT score may be 1200, the student's position relative to the selected college's student body may be in the top 25%. Statistically, students in the quartile may have fared well in the admission process, and have received more financial aid offers from colleges than students with scores that fall into the middle 50% or bottom 25% quartile.

In an example, a student with an SAT score of 1000 would qualify academically for admission to the selected college. However, the student's score would place them in a very disadvantageous position for receiving an offer of financial aid, the student's academic ranking may be lower than 75% of the student body for the selected college. This position within the student body would increase the risk of the applying student being denied admission, or if the applying student may be accepted by the selected college, minimizing the applying students financial aid opportunities from the selected college.

Continuing with the example, a student with an SAT score of 1100 would qualify academically for admission to the selected college. However, the student's score would place them in a less advantageous position for receiving an offer of financial aid, indicating the student's academic ranking may be lower than 50% of the student body for the selected college. The student's position within the student body increases the likelihood for admission to the selected college, but the opportunities for financial aid from the college are still considered relatively low, due to the student's academic ranking within the student body.

A student with an SAT score of 1200 would qualify academically for admission to the selected college. Here, as indicated, the student's score would place them in an advantageous position to receive an offer of financial aid, indicating the student's academic ranking may be in the top 25% of the student body for the selected college. The student's position within the student body substantially increases the likelihood for admission to the selected college as well substantially increasing the opportunities for financial aid and scholarships from the selected college.

With a score of 1250, the student would fall within the top 10% of the student body for the selected college. This position within the student body virtually guarantees admission to the selected college as well as substantial opportunities for financial aid and scholarships form the selected college.

In an example, after a first order search and placement has been performed as a function of the student's SAT and/or ACT score, a search may utilize other secondary factors. Factors such as high school grade point average (“GPA”), high school class rank, diversity/out of region/out of state factors, and enrollment yield may be used to further adjust the position of the student on the grid of the selected college. If, for example, the prospective student's GPA may be above average with respect to the student body of the selected college, in this example, the method and system may improve the student's position for receiving financial aid offers at one or more colleges. If the student's high school class rank may be higher than the average of the selected college student body, in this example, the method and system may improve position for receiving financial aid offers from one or more colleges. Conversely, if the student's high school class rank may be lower than the average of the selected college student body, the system and method may predict a reduced likelihood and amount of financial aid being offered.

Diversity may be an important consideration in the college admission process. Diversity may be defined ethnically or regionally, i.e., where the student lives or resides. When the student may be from a diverse ethnic background, or from a diverse regional background. This consideration may improve the likelihood of admission and predicted amount of financial aid for one or more colleges.

Enrollment yield, which may be defined as the percentage of students that actually enroll after they have been accepted by a college, may impact predicted financial aid offers. When enrollment yield may be high, the selected college may provide smaller financial incentives to students. Conversely, when enrollment yield may be low, the selected college may provide substantially larger financial incentives to prospective students to entice them to enroll in the selected college.

In an example, a method and system may include evaluating a group of prospective colleges with respect to predicted aid offers for the prospective student, and with respect to predicted cost of attendance for the prospective student. Predicted aid offers may include: predicted aid awarded for academic qualifications, predicted need-based aid, predicted merit-based aid, and predicted strategic aid offers, for each of the colleges.

In an example, for a preselected college under consideration by a prospective student, it may be predicted by reference to enrollment and aid figures that have been self-reported by the college for the most recent academic year, that the preselected college may be predicted to provide 24% of the students a predicted average financial aid package of $24,000 per student in the predicted applicant pool, i.e., if the prospective student falls within the top 24% of the predicted applicant pool, that student may be predicted to receive a predicted merit-based aid offer from the selected college. The predictive academic modeling, predictive business modeling, strategic aid modeling, and predictive enrollment decision modeling may predict aid offers to the prospective student for the college by reference to the prospective student's position within the predicted applicant pool of applicant pool modeling, predicted acceptance pool of acceptance pool modeling, or predicted enrollment pool of enrollment pool modeling, or predictive enrollment decision modeling.

In an example, if the prospective student is predicted to be ranked in the top 12% of the predicted applicant pool, for example, it may be predicted that the prospective student will receive a predicted aid offer in the predicted average financial aid offer of $24,000, or higher. Conversely, if the prospective student is predicted to be ranked in the lower 12% of the applicant pool, for example, the predicted merit-based aid offer may be reduced below average, for example by 1% for each percentile the student may be ranked below the 12% ranking. If the prospective student's SAT/ACT score may be higher than the predicted average SAT/ACT score of the predicted applicant pool, the predicted merit-based offer may be increased above average, for example by 1% for each percentile the student may be ranked above the 12% ranking. Where predicted merit-based aid is increased in this manner, it will be appreciated that such increase may be capped, for example at two-thirds of the predicted total cost of attendance for the college. For example, for a selected college where it is predicted that 24% of prospective students receive a predicted average merit-based aid offer of $24,000 and the prospective student is predicted to be ranked in the 18th percentile of the predicted applicant pool, the predicted merit-based aid offer may be decreased by each percentile the prospective student may be below the 12% ranking, i.e., $1,000 per percentile below the 12% ranking. In an example, where the prospective student's actual SAT/ACT score or academic profile criteria for determining a merit-based aid offer is 6% percentile points below the predicted average student SAT/ACT score or academic profile criteria for determining a merit-based aid offer, the predicted merit-based aid offer may be reduced below the predicted average merit-based offer ($24,000), by the difference of percentile (in the example, negative 6 percentile points difference between prospective student and predicted average applicant pool for the academic criteria, is multiplied by $1,000 per percentile, totaling a $6,000 reduction of the predicted merit-based aid offer), or net predicted merit-based aid offer in the amount of $18,000. If, however, the prospective student is predicted to be ranked above the predicted average 12% ranking of students in the predicted applicant pool, the predicted merit-based aid offer will be increased according to each percentile the prospective student may be above the predicted average 12% ranking of students in the predicted applicant pool, i.e., $1,000 per percentile above the 12% ranking. In this example, where the prospective student is predicted to be ranked in the top 8% of the predicted applicant pool, the prospective student may be predicted to be 4% above the predicted average 12% ranking of the predicted applicant pool. Therefore, a predicted merit-based aid offer to the prospective student from the selected college is the predicted average merit-based aid offer ($24,000), increased for the predicted 4 percentage points difference between the prospective student (in this example, $1,000 per point multiplied by 4 points, totaling $4,000) and the predicted average of the applicant pool for the academic criteria for determining merit-based aid, for a predicted merit-based aid offer in the amount of $28,000 (the sum of $24,000 of $4,000). The predicted merit-based aid offer may be subject to a ceiling, i.e., two-thirds of cost of attendance (“COA”). For example, if the predicted cost of attendance is $40,000 for the college, a predicted maximum merit-based aid offer may be $26,400 (two-thirds of $40,000). Different predicted merit-based aid offers for a prospective student may be determined for each college of interest to the prospective student.

In an example, predicted burden on family assets of a prospective student may be modeled and predicted. Family assets of a prospective student, for example, may include stocks, bonds, mutual funds, and 529 college savings plans. According to the United States Department of Education rules for applying for Federal Student Aid (FAFSA), family assets of a prospective student, including stocks, bonds, mutual funds, and 529 college savings plans, may be considered in modeling college aid offers and predicting college aid offers for a prospective student. It may be noted, for example, that 529 college savings plans may be weighted more heavily by various colleges, because the 529 college savings plans are an asset that is regularly utilized for payment of college expenses. A predicted merit-based aid offer to a prospective student may be reduced, where family assets are held by family of the prospective student. For example, a predicted merit-based aid offer may be reduced in relation to family assets, as follows:

| | | Decrease in Award | Decrease in Award |
|---|---|---|---|
| | Asset Held | (Percentage) | (Dollars) |
| A. | $15,000-$25,000 | 7.5% | $1,875 |
| B. | $25,001-$50,000 | 10% | $5,000 |
| C. | $50,001-$75,000 | 12.5% | $9,375 |
| D. | $75,001-$100,000+ | 15% | $15,000 |

In the example illustrated immediately above, where a college is predicted to provide 24% of applicants an average of $24,000 per applicant, a merit-based aid offer to a prospective student may be decreased by the college's strategic enrollment management system as a function of family assets of the prospective student, as follows:

| | | Decrease in Award | Adjusted Award Offer |
|---|---|---|---|
| | Asset Held | (Dollars) | (Dollars) |
| A. | $24,000 | $1,875 | $22,125 |
| B. | $24,000 | $5,000 | $19,000 |
| C. | $24,000 | $9,375 | $14,625 |
| D. | $24,000 | $15,000 | $9,000 ($12,000) |

In an example, the predicted average merit-based aid offer ($24,000) for the applicant pool may be reduced by the college considering family assets of the prospective student, to 50% of the predicted average merit-based aid offer, which in this example is $12,000 (50% of the predicted average merit-based aid offer $24,000).

Thus, it will be understood that this disclosure provides improved methods, apparatus and systems for predictive management of college search information and college selection information. Those skilled in the art may recognize that modifications and variations may be made without departing from the spirit of our invention. Therefore, we intend that our embodiments encompass all such variations and modifications as fall within the scope of the appended claims.

1. A system for predictive management of college search information, said system comprising:
a college admission event information handler, implemented by a processor, configured to build a college admission event model from historical college admission event information by accessing a database of college admission events associated with a plurality of colleges, each of the college admission events being associated with a college identifier and an event type; and
an application submission engine, implemented by a processor, configured to:
receive a query from a device associated with a user, the query including applicant identifier, academic profile, financial profile, and a plurality of college identifiers;
access a predictive enrollment decision model, the predictive enrollment decision model determining a plurality of predicted enrollment decisions for an applicant associated with the applicant identifier, the plurality of predicted enrollment decisions being determined in relation to each college corresponding to the plurality of college identifiers for the applicant identifier, for each college identifier the predictive enrollment decision model accessing the college admission event model where the event type is a financial aid offer, the predictive enrollment decision model building a financial aid offer model by accessing the college admission event model for each college corresponding to the plurality of college identifiers where the event type is a financial aid offer, the financial aid offer model including a strategic aid offer component determined from a model of a strategic enrollment management system for the college corresponding to the college identifier, the model of a strategic enrollment management system including at least one representation of a strategic tactic of the college, the predictive enrollment decision model determining a plurality of predicted financial aid offers for the applicant by accessing the financial aid offer model for each college identifier in relation to the academic profile and financial profile for the applicant identifier;
construct predicted net cost of attendance for the applicant for each college of the plurality of colleges by accessing a database including gross cost of attendance for each college identifier and accessing the plurality of predicted financial aid offers for the applicant identifier, to determine net cost of attendance for the applicant for each college;
generate an application submission indicator for the applicant identifier for each college identifier, by accessing the predicted net cost of attendance for the applicant identifier for each college identifier.

2. The system of claim 1, further comprising:
wherein historical college admission events for a plurality of colleges are received by the college admission event handler.

3. The system of claim 2, further comprising:
wherein each historical college admission event for the plurality of colleges is associated with a college identifier and event type by the college admission event information handler.

4. A method for predictive management of college admission information, performed by a processor, the method comprising:
first accessing a college admission event information handler, implemented by a processor, to build a college admission event model from historical college admission event information by accessing a database of college admission events associated with a plurality of colleges, each of the college admission events being associated with a college identifier and an event type; and
accessing an application submission engine, implemented by a processor, the application submission engine:
receiving a query from a device associated with a user, the query including applicant identifier, academic profile, financial profile, and a plurality of college identifiers;
accessing a predictive enrollment decision model, the predictive enrollment decision model:
determining a plurality of predicted enrollment decisions for an applicant associated with the applicant identifier, the plurality of predicted enrollment decisions being determined in relation to each college corresponding to the plurality of college identifiers for the applicant identifier,
for each college identifier accessing the college admission event model where the event type is a financial aid offer,
building a financial aid offer model by accessing the college admission event model for each college corresponding to the plurality of college identifiers where the event type is a financial aid offer, the financial aid offer model including a strategic aid offer component determined from a model of a strategic enrollment management system for the college corresponding to the college identifier, the model of a strategic enrollment management system including at least one representation of a strategic tactic of the college,
determining a plurality of predicted financial aid offers for the applicant by accessing the financial aid offer model for each college identifier in relation to the academic profile and financial profile for the applicant identifier.

5. The method of claim 4, further comprising:
constructing, by the predictive enrollment decision model, predicted net cost of attendance for the applicant for each college of the plurality of colleges by accessing a database including gross cost of attendance for each college identifier and accessing the plurality of predicted financial aid offers for the applicant identifier, to determine net cost of attendance for the applicant for each college.

6. The method of claim 4, further comprising:
generating an application submission indicator for the applicant identifier for each college identifier, by accessing the predicted net cost of attendance for the applicant identifier for each college identifier.

7. The method of claim 4, further comprising:
wherein historical college admission events for a plurality of colleges are received by the college admission event handler.

8. The method of claim 7, further comprising:
wherein each historical college admission event for the plurality of colleges is associated with a college identifier and event type by the college admission event information handler.

9. A system for predictive management of college search information, said system comprising:
a college admission event information handler, implemented by a processor, configured to build a college admission event model from historical college admission event information by accessing a database of college admission events associated with a plurality of colleges, each of the college admission events being associated with a college identifier and an event type;
an application submission engine, implemented by a processor, configured to:
receive a query from a device associated with a user, the query including applicant identifier, academic profile, financial profile, and a plurality of college identifiers;
access a predictive enrollment decision model, the predictive enrollment decision model determining a plurality of predicted enrollment decisions for an applicant associated with the applicant identifier, the plurality of predicted enrollment decisions being determined in relation to each college corresponding to the plurality of college identifiers for the applicant identifier;
for each college identifier the predictive enrollment decision model accessing the college admission event model where the event type is a financial aid offer, the predictive enrollment decision model building a financial aid offer model by accessing the college admission event model for each college corresponding to the plurality of college identifiers where the event type is a financial aid offer;
the financial aid offer model including a strategic aid offer component determined from a model of a strategic enrollment management system for the college corresponding to the college identifier, the model of a strategic enrollment management system including at least one representation of a strategic tactic of the college.

10. (canceled)

11. (canceled)

12. The system of claim 11, further comprising:
the predictive enrollment decision model determining a plurality of predicted financial aid offers for the applicant by accessing the financial aid offer model for each college identifier in relation to the academic profile and financial profile for the applicant identifier.

13. The system of claim 9, further comprising:
the application submission engine further configured to:
construct predicted net cost of attendance for the applicant for each college of the plurality of colleges by accessing a database including gross cost of attendance for each college identifier and accessing the plurality of predicted financial aid offers for the applicant identifier, to determine net cost of attendance for the applicant for each college.

14. The system of claim 9, further comprising:
the system configured to:
generate an application submission indicator for the applicant identifier for each college identifier, by accessing the predicted net cost of attendance for the applicant identifier for each college identifier.

15. The system of claim 9, further comprising:
wherein historical college admission events for a plurality of colleges are received by the college admission event handler.

16. The system of claim 15, further comprising:
wherein each historical college admission event for the plurality of colleges is associated with a college identifier and event type by the college admission event information handler.
